(19) United States
(12) Patent Application Publication
(10) Pub. No.: US 2006/0206930 A1
(43) Pub. Date: Sep. 14, 2006

(54) Method and system for rendering single sign on

(76) Inventors: Golan Parashi, Givatayim (IL); Leedor Agam, Savion (IL); Yanki Margalit, Ramat-Gan (IL); Dany Margalit, Ramat-Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/073,672

(22) Filed: Mar. 8, 2005

(51) Int. Cl. G06F 17/30

(52) U.S. Cl. 726/8

(57) ABSTRACT

The present invention is directed to a method for rendering single sign on by a user and a system thereof. The method comprises the steps of providing the user with at least one template for uniquely identifying a window; detecting an opened window; identifying the window by the at least one template; and activating a corresponding profile to the window, the profile being for filling-in at least one value in a corresponding input field of the window. The system may comprise a security token for storing information to be filled-in in behalf of said user in at least one input field of a window of a software application, thereby rendering single sign on without an SSO server, and securely storing said information.

This is a continuation-in-part of U.S. Provisional Patent Application identified as Attorney's Docket 2311, delivered to the USPTO on Dec. 10, 2004, by FedEx shipment No. 621360075235.

### FIELD OF THE INVENTION

The present invention relates to the field of Single Sign On.

### BACKGROUND OF THE INVENTION

Nowadays a common enterprise user uses a plurality of accounts, each one for a different corporate system, resource, etc. (referred herein as “domain”), and sometimes even for a plurality of accounts to the same domain. Due to the plurality of accounts, the common user has to sign on to each domain with a different user name and password. In order to remember these passwords, a user often tends to write them down, which is a burden to the user. In order to facilitate the sign on process, he usually uses easy-to-remember passwords, and even worse, he uses the same password for a plurality of domains and accounts, which results in a security lack.

These drawbacks are currently solved by a solution which is known in the art as Single Sign On (SSO). An SSO system employs a single sign on operation for signing on to a plurality of domains. Instead of signing on each domain separately, the user signs on only to the SSO system. This concept is illustrated in FIG. 1, which describes an SSO system according to the prior art. An SSO server 10 signs on behalf of the user 30 to domains 20 (e.g. application 21, resource 22, network 23).

SSO systems provide the following benefits:
A user does not have to remember all its domains' passwords (user ID, etc.), but rather one password.
Complex sign on information can be used, thereby improving the security level (the more complex the sign on information, the harder to be “hacked”).
User is relieved of the duty to fill-in sign on information manually thereby more convenient operation regarding sign on is achieved.

On the other hand, as a password dependent system, the major drawback of this approach is that the strength of the security depends on the strength of the password that a user uses for signing on an SSO system. A well known drawback of a password that has to be manually entered by a user is that such password tends to be “simpler” (e.g. meaningful words, shorter words, employing only A-Z characters, etc.), and therefore easier to be “hacked”. Furthermore, sign on schemes usually enable a user that has forgotten his password to use an alternative password as an answer to a question such as “what is your marriage date”, “what is your pet's name”, etc., which can easily “hacked”.

Therefore, it is an object of the present invention to provide a method and system for rendering Single Sign On, which is simpler to be operated by a user than in the prior art.

It is another object of the present invention to provide a method and system for rendering Single Sign On, in which no user intervention is required in filling in sign on information, and thereby more complicated passwords can be used.

It is yet another object of the present invention to provide a method and apparatus for rendering Single Sign On, in which no SSO server is employed.

It is still an object of the present invention to provide a method and system for rendering Single Sign On, which is easier and faster to be integrated with an application than in the prior art.

Other objects and advantages of the invention will become apparent as the description proceeds.

### SUMMARY OF THE INVENTION

In one aspect the present invention is directed to a method for rendering single sign on by a user, the method comprising the steps of: providing the user with at least one template for uniquely identifying a window; detecting an opened window; identifying the window using the at least one template; and activating a profile, corresponding to the window, for filling-in at least one value in a corresponding input field of the window.

A template may comprise data and/or execution code. A profile may comprise also data and/or execution code. The data of a profile may comprise at least one value which has been filled-in by the user in an input field of the window. According to one embodiment of the invention a profile is kept in a secured form, e.g. in an encrypted form.

According to one embodiment of the invention the profile is stored in a repository residing on a machine (e.g. computer) of the user. According to another embodiment of the invention the profile is stored in a repository residing on a remote location accessible over a network by a machine of the user. According to yet another embodiment of the invention the profile is stored in a repository residing on a security token accessible by a machine of the user.

According to one embodiment of the invention detecting an opened window is carried out by examining system messages regarding events occurring in the machine of the user. According to another embodiment of the invention detecting an opening window is carried out by comparing a recent list of opened windows on the machine of the user with a previous list of opened windows on the machine of the user. Identifying the window may be carried out by a match between a value of at least one parameter of the window and a corresponding value thereof. Execution code may also be employed for identifying the window.

According to one embodiment of the invention, the activation of a corresponding profile to the window comprises filling in at least one input field of the window according to the second set of one or more rules.

In another aspect, the present invention is directed to a system for rendering single sign on by a user, the system comprising: a templates repository for storing at least one template for uniquely identifying a window, the templates repository being accessible by a machine of the user; a profiles repository, accessible to the machine of the user, for storing at least one profile for filling-in at least one value in a corresponding input field of the window; and an agent at the machine of the user, for identifying the window upon opening, and for activating a corresponding profile for filling-in at least one value in at least one input field of the window.

The profiles repository may reside at a machine of the user, at a remote location accessible over a network by a machine of the user, at a security token accessible by a machine of the user, and so forth.

In yet another aspect, the present invention is directed to a system for rendering single sign on by a user, the system comprising a security token for storing information to be filled-in in behalf of the user in at least one input field of a window of a software application (including a Web browser), thereby rendering single sign on without a server, and securely storing the information.

### BRIEF DESCRIPTION OF THE DRAWINGS

The present invention may be better understood in conjunction with the following figures:

FIG. 1 schematically illustrates an SSO system, according to the prior art.

FIG. 2 is a flowchart of a method for rendering single sign on, according to a preferred embodiment of the invention.

FIG. 3 illustrates a sign on window.

FIG. 4 is a table of the parameters of the SEND button of FIG. 3.

FIG. 5 is a flowchart of a method for identifying a window using templates, according to a preferred embodiment of the invention.

FIG. 6 is a flowchart of a process for activating a profile, according to one embodiment of the invention. It specifies block 330 of FIG. 5.

FIG. 7 schematically illustrates an SSO system, according to a preferred embodiment of the present invention.

FIG. 8 schematically illustrates an SSO system, according to another preferred embodiment of the invention.

FIG. 9 schematically illustrates an SSO system, according to yet another embodiment of the invention.

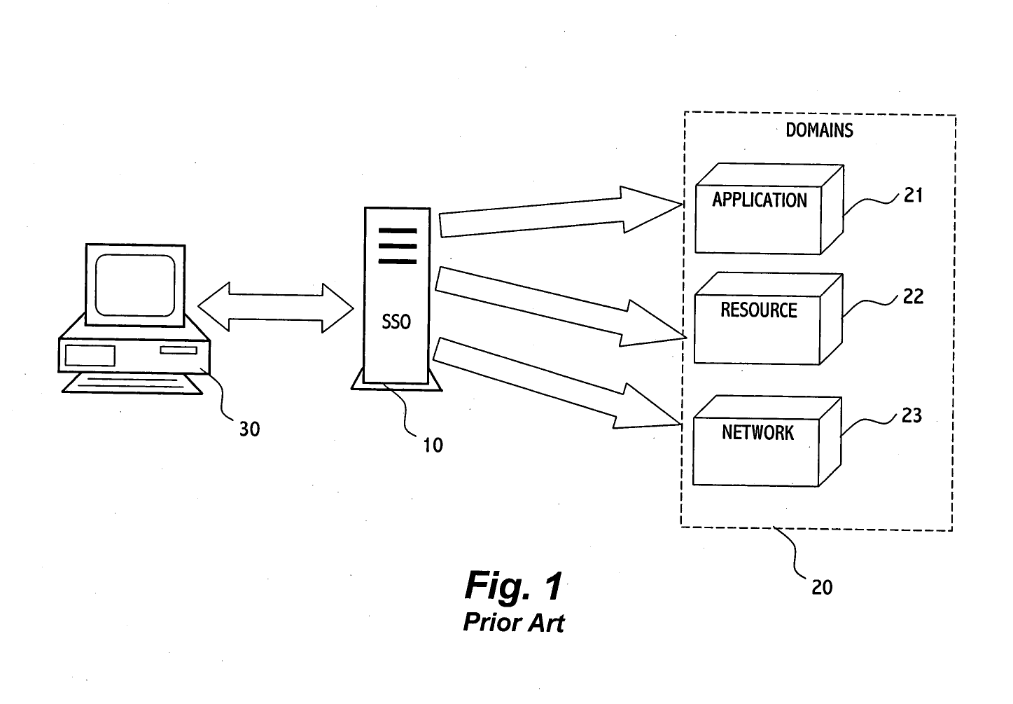

### DETAILED DESCRIPTION OF PREFERRED EMBODIMENTS

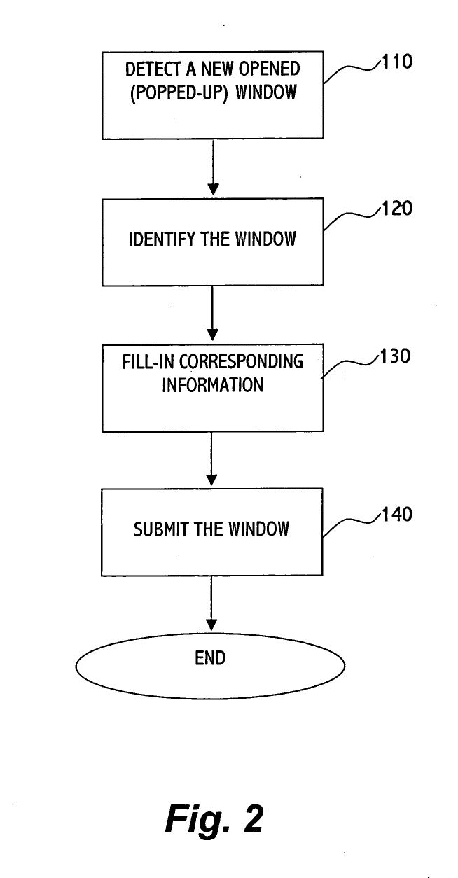

FIG. 2 is a flowchart of a method for rendering single sign on, according to a preferred embodiment of the invention.
At block 110, a new opened window (i.e. “popped-up”) is detected.
At block 120, the window is identified. Uniquely identifying a window is a problematic issue. It is discussed hereinafter.
At block 130, after a window has been identified, corresponding information is filled-in the window's input fields.
At block 140, the filled-in information is submitted (e.g. when the user clicks the “OK” button).
   Detecting New Opened Windows

According to one embodiment of the invention, detecting a popped-up window is carried out by system API functions which “listen” to messages regarding events that happen in the system. One of the events that are reported by such messages is opening a new window.

According to another embodiment of the invention, an agent executed on user's computer (also referred as to “SSO client”) gets a list of opened windows from the operating system, and compares it with a previous list of opened windows. By comparing the current list with the previous list, new opened windows can be detected. Such an operation can be carried out periodically (for example each N seconds). Of course the comparison can also be carried out when a new window pops up.

Uniquely Identifying a Window

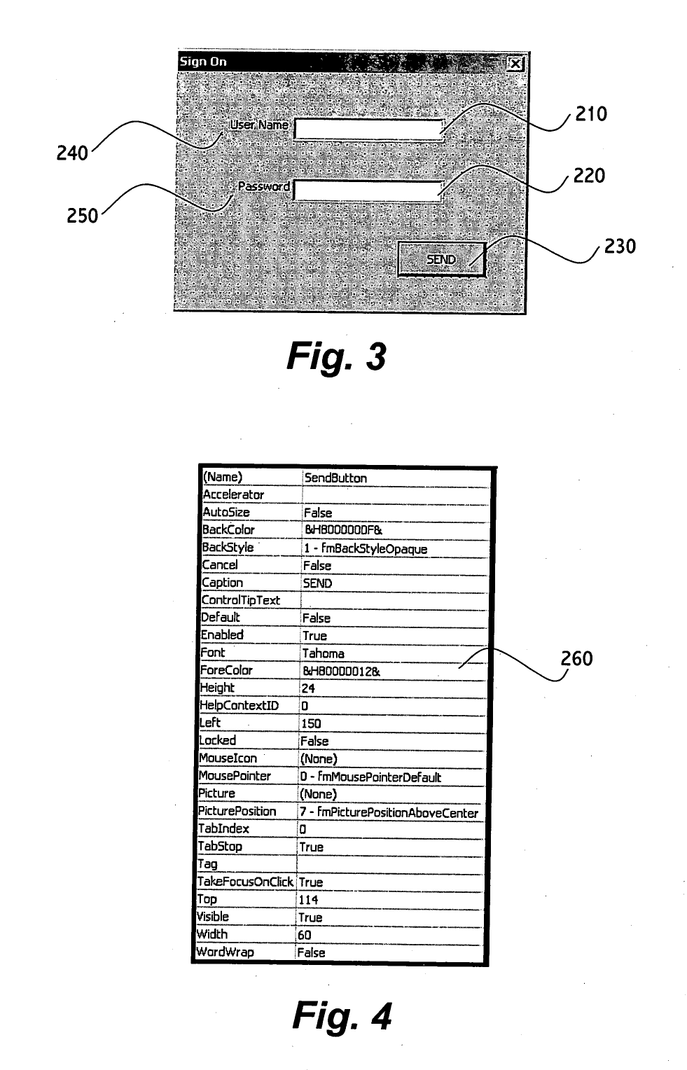

FIG. 3 illustrates a sign on window. The window comprises the following elements: Input fields 210 and 220, Send button 230, caption controls 240 and 250. When a user clicks the SEND button, the information typed in the input fields is sent to a destination thereof. An application can be designed to cooperate with an SSO system, i.e. to provide to the SSO system a unique identifier to the opened window, which fields is expected to be filled-in, etc. However SSO systems are designed to operate with any application, not necessarily with applications that have been designed to support SSO. Therefore the issue of uniquely identifying a window is essential to the present invention.

FIG. 4 is a table of the parameters of the SEND button 230 of FIG. 3. Table 260 comprises a plurality of parameters. The window illustrated in FIG. 3 and its elements 210 to 250 comprise also a plurality of parameters. According to a preferred embodiment of the invention, a window is uniquely identified according to values of its parameters and/or values of the parameters of its elements. Of course not all the parameters have to be taken in consideration. Typically a window can be uniquely identified by the Caption of the window and the text within the window and controls (e.g. buttons, input fields, etc.). However, sometimes these parameters are not adequate to uniquely identify a window, and therefore employing executable code for this matter may be helpful.

Templates

The term “template” refers herein to a set of one or more rules for identifying a window.

For example, a log-on window of an application can be identified by the presence of the text “Please enter your password” in the window. Thus, a template for identifying a window as the log-on window has to look for certain text within the window's fields.

A template's rule can comprise data and/or execution code, such as script. Typically a template is oriented to identify a certain window. Thus, in order to identify a window, according to one embodiment of the invention the templates are activated one by one, until one of the templates identifies the window, or until the last template fails to identify the window. Of course in order to expedite the process, only certain templates may be activated. For example, activating only the templates that belong to a certain application; activating only templates that deal with the same type of the opened window, etc.

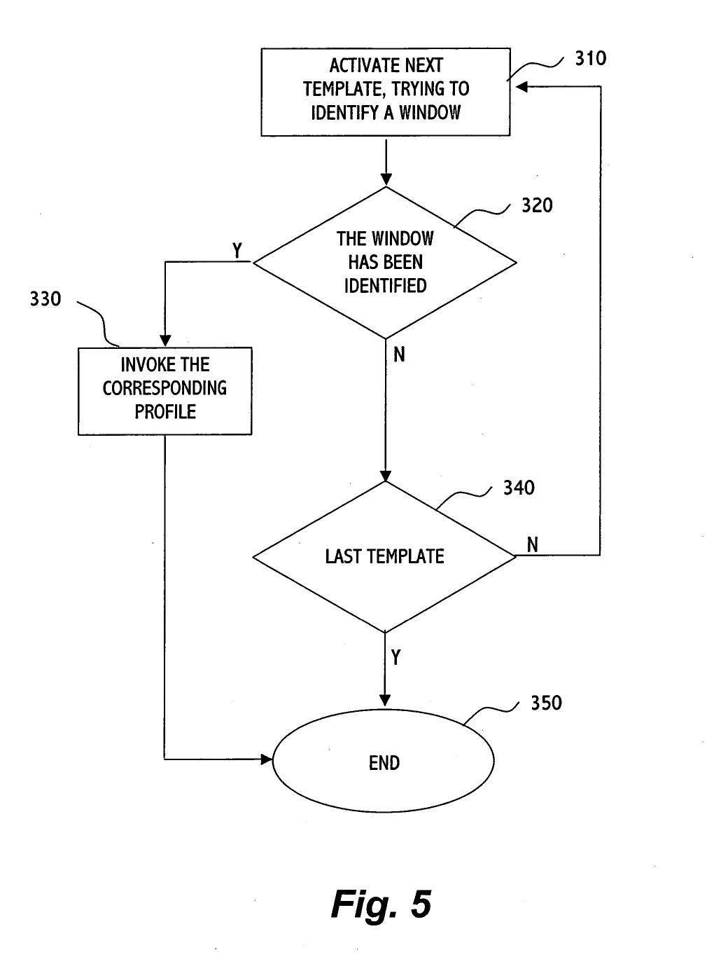

FIG. 5 is a flowchart of a method for identifying a window using templates, according to a preferred embodiment of the invention.
At block 310 the next template in the relevant group of templates (e.g. that belong to an application and deal with the same type of window as the current tested window) is activated.
From block 320, if the activated template identifies the window, then on block 330 a corresponding “profile” (defined hereinbelow) is retrieved, and its information is “manipulated” (e.g. filled-in the appropriate fields of the window, the window is submitted, a script is activated, etc.), and then the process ends on block 350.
In case the template couldn't identify the window, from block 340 if the current template is the last template of the group, then the process ends on block 350, otherwise the process continues with block 310, where an attempt to identify the window is carried out by the next template of the group.
   Profiles

The term “profile” refers herein to a set of one or more operations to be performed upon identifying a window.

A typical operation of a profile is filling in corresponding details in the input fields of the window, such as user name, password, user ID, PIN, credit card details, etc. A profile may comprise also execution code. For example, in case where the user has to change his password once in a while, i.e. when the data is not static, the execution code can generate a random password according to the password policy of the organization (e.g. at least 8 characters, of which at least one is a symbol).

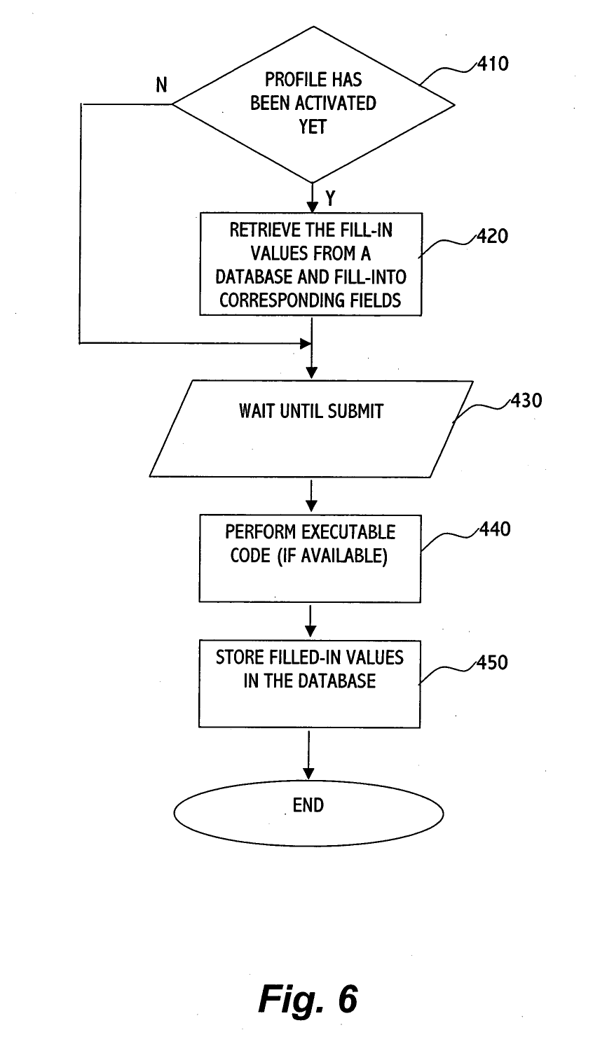

FIG. 6 is a flowchart of a process for activating a profile, according to one embodiment of the invention. It specifies block 330 of FIG. 5.
From block 410, if the profile that corresponds to the opened window has not been activated before by the user then flow continues to block 420, otherwise to block 430.
On block 420 the information to be filled-into the fields of the opened window are retrieved from a database and filled-into the corresponding fields of a window.
Block 430 denotes a “wait” operation. Actually, the flow continues to block 440 when the filled-in information is submitted, for example when the user has clocked the OK or SEND button.
At block 440 if the profile comprises executable code, then the executable code is executed. The ability to execute an executable code is for allowing operations which are more complicated that filling in values into corresponding fields. This way the behavior of an application program can be modified. For example, using executable code a user can keep a history of the entrances to his bank account.
On block 450 the current filled-in information is stored in a database as the corresponding information of this window. The next time that this window is activated, the information is retrieved from the database, and filled-into the corresponding fields of the window.
   An SSO System

The term “repository” refers herein to means for storing digital information, such as a file, memory, database, a remote digital storage, etc.

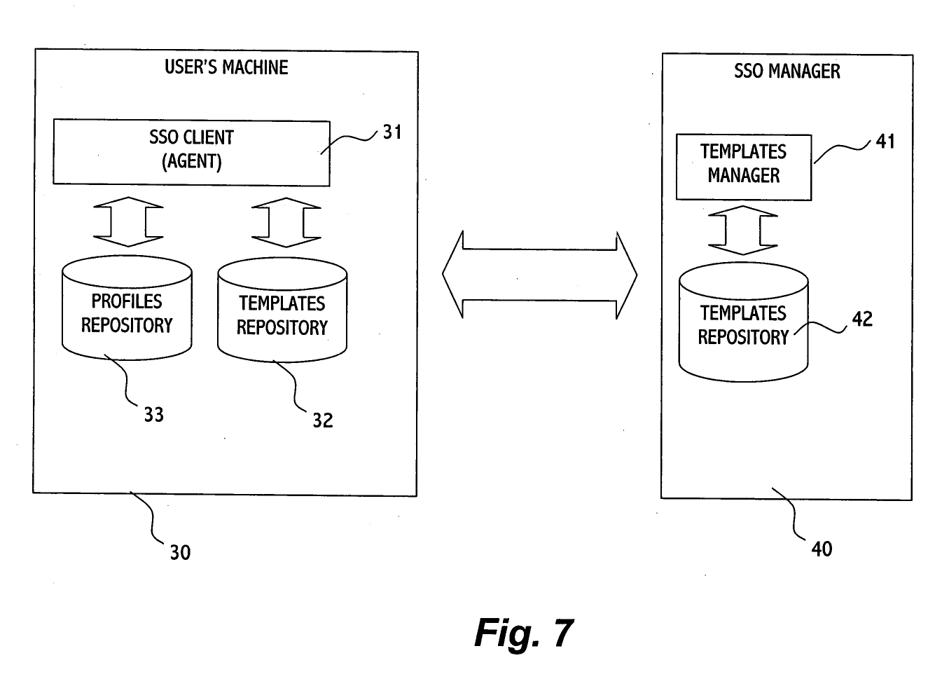

FIG. 7 schematically illustrates an SSO system, according to a preferred embodiment of the present invention. From the operational point of view, the SSO system comprises the following components:
An SSO manager 40, which is a platform for:
   an SSO templates repository 42, for storing templates.
   a Template Manager 41, for managing (creating, editing, modifying, retrieving, etc.), and optionally distributing the templates to users' machines.
      At the user machine:
A templates repository 32, for storing templates.
A profiles repository 33, which is a collection of fill-in information and/or procedures to be carried out upon identifying a window.
An SSO client 31, which is a software application to be executed at the user's machine (also referred herein as “agent”), for at least:
   detecting a new opened window on user's machine;
   identifying the window using said templates; and
   invoking a profile that corresponds to the identified window.

It should be noted that in contrast to SSO systems of the prior art, an SSO system according to the present invention does not comprise an online SSO server, since the templates reside at the user's side. The absence of an online server in an SSO system simplifies the operation of the system, at least since no entity should be present 24 hours a day.

Moreover, since according to the present invention no online SSO server is required, user's information (such as e.g. passwords, credit number details, credentials, etc.) is stored at the user's side instead of at the server side as in the prior art. As a result according to the present invention user's information is more secured than according to the prior art. In order to keep profiles even in a more secured manner, the profiles can be kept in an encrypted form.

Employing a Security Token in an SSO System

The term security token (sometimes called also authentication token) refers herein to a typically small and mobile device that stores information in a secured manner, typically using hardware protection means such as smart card, and connects to a computer via wired (e.g. USB) or wireless (e.g. infrared) means. The eToken®, which is manufactured by Aladdin Knowledge Systems Ltd., is an example of a security token.

Since a security token provides hardware protection to data it stores, the stored information is more secure than information stored at a computer, even in case where the information is kept at the computer in an encrypted form.

Security tokens usually have also an ability to render cryptographic operations. Therefore confidential information stored within a security token is usually kept in an encrypted form.

In addition to the security virtues, a security token provides also portability. Thus, using a security token for storing profiles (and also templates) a user may implement an SSO logon from different computers.

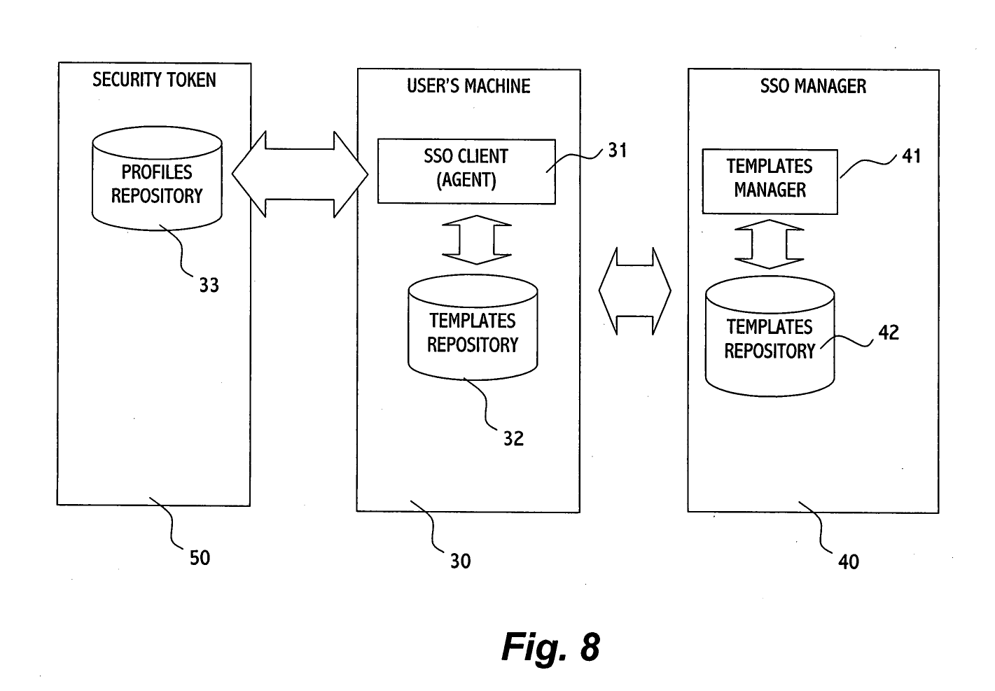

FIG. 8 schematically illustrates an SSO system, according to another preferred embodiment of the invention. According to this embodiment the profile database 33 is stored within a security token 50 rather than on user's machine 20. In addition the templates may also be stored in the security token.

In order to provide even a better security level, a method known as two-factor authentication may be employed. Two-factor authentication is based on employing two information entities for authentication: something a user knows (e.g. a password) and something the user has (e.g. a unique security token). Typically interacting with a host in a two-factor authentication session is carried out by a challenge/response process. One-time password methods can also be employed for achieving better security level. In this case each time a user requests a service, a different password is employed.

According to one embodiment of the invention, the communication between the user's machine 30 and the security token 50 is encrypted in order to gain even a better security level.

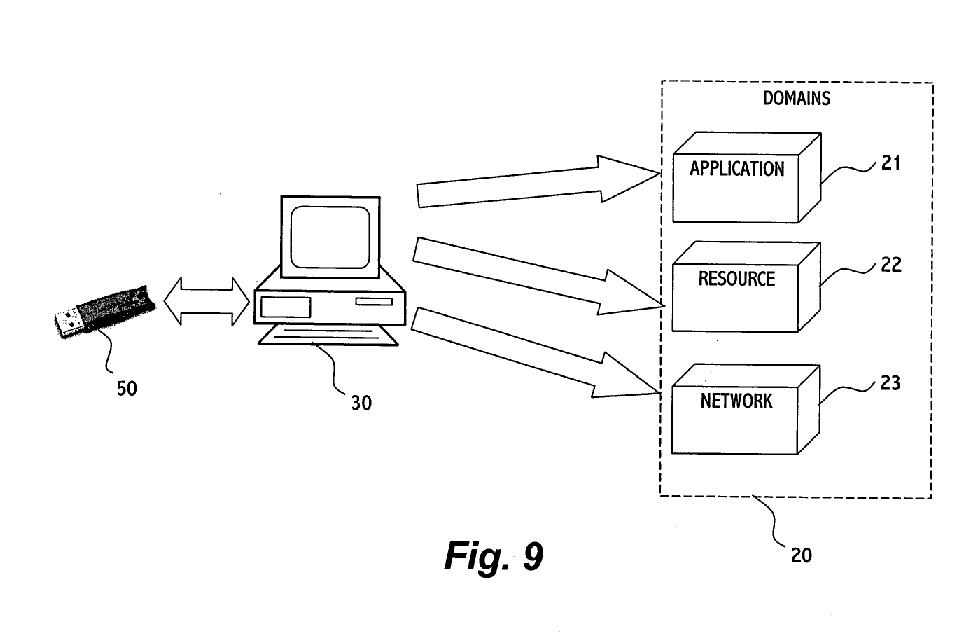

FIG. 9 schematically illustrates an SSO system, according to yet another embodiment of the invention. According to this embodiment, the user's SSO information is stored in the security token 50. The applicant regards the use of a security token for storing user's SSO information (for example, user's credentials, passwords, user IDs, and so forth) as innovative in SSO systems. By storing user's SSO information in a security token instead of at the server side or at the user's machine, the information, which has sensitive nature, is stored in a more secured manner than in the prior art.

Implementing a security token in an SSO system provides the following benefits:
User's information (profiles, templates) is secured by hardware means, thereby providing a higher security level.
User's information is not available through a network, thereby the information is kept out of the reach of hackers.
Help-desk calls for password reset are reduced.
No SSO server is required. As a result, signing on to a domain is not suspended when an SSO server is out of order.
The mobility of a security token enables to sign on to a domain from different terminals.
   Implementing the Invention in an Organization

One object of the present invention is to simplify access control and identity management in an enterprise environment (a firm, an Internet Service Provider, etc.). In today's world, most enterprise applications impose an access control mechanism and require user identification before access is permitted. Most applications use the old-fashioned user name and password concept to allow access. When using a password, one should remember the disadvantages thereof—passwords are costly to administer, hard to remember and vulnerable to attacks. The present invention simplifies the use of passwords, enabling the user to remember only one PIN (Personal Identification Number) and then apply the right credentials to the application when it opens on the user's desktop.

The present invention may be used in an organization (a firm, an Internet Service Provider, etc.) environment. The present invention provides to a system administrator a complete control over the allocation and deployment of the SSO within the organization, since the system administrator can decide which templates to distribute to a user, and which individual sign on characteristics to allow to a certain user. A system administrator can create new templates for an application, create additional templates for the application or where applicable to add an additional window for the same template.

The use of templates is very useful in an organization. An organization typically employs an IT (Information Technology) team for maintaining organization's computerized systems. After an IT team creates templates for identifying sign on windows of an application (e.g. the mail system of the organization), the created templates can be distributed to the users of the organization. Once an Administrator of an SSO system has set up the necessary templates, the user can create profiles on his personal security token for these applications. Users can create a new profile for an application, create additional profiles for that application or where applicable add an additional window for the same profile. An SSO Client stores authentication credentials for a given application in a profile.

Implementing the Invention in an Individual User Machine

According to a preferred embodiment of the invention, the templates created for signing on to an application are distributed to its users, any users, not necessarily the users of an organization. Thus, an application program can be distributed by its manufacturer/vendor with pre-prepared templates thereof.

According to one embodiment of the invention, templates are distributed to a user's machine by common methods for distributing software and/or data, such as via the Internet, online installation, installation disk, etc. Furthermore, a template can reside on other places than on the user's machine, as long as it is accessible to a user's machine. Thus, a template may reside on a remote server, and be accessible to the user's machine via a network such as LAN, WAN and Internet.

Those skilled in the art will appreciate that the invention can be embodied by other forms and ways, without losing the scope of the invention. The embodiments described herein should be considered as illustrative and not restrictive.

1. A method for rendering single sign on by a user, the method comprising the steps of:
providing said user with at least one template for uniquely identifying a window;
detecting an opened window;
identifying said window using said at least one template; and
activating a profile, corresponding to said window, for filling-in at least one value in a corresponding input field of said window.

2. A method according to claim 1, wherein said one or more templates comprise data.

3. A method according to claim 1, wherein said one or more templates comprise execution code.

4. A method according to claim 1, wherein said one or more profiles comprise data.

5. A method according to claim 1, wherein said one or more profiles comprise execution code.

6. A method according to claim 4, wherein said data comprises at least one value filled-in in an input field of said window by said user.

7. A method according to claim 1, wherein said profile is kept in a secured form.

8. A method according to claim 7, wherein said secured form is an encrypted form.

9. A method according to claim 1, wherein said profile is stored in a machine of said user.

10. A method according to claim 1, wherein said profile is stored at a remote location accessible over a network by a machine of said user.

11. A method according to claim 1, wherein said profile is stored in a security token accessible by a machine of said user.

12. A method according to claim 1, wherein said detecting of said opened window is carried out by examining system messages regarding events occurring in a machine of said user.

13. A method according to claim 1, wherein said detecting of said opened window is carried out by comparing a recent list of opened windows on a machine of said user with a previous list of opened windows on the machine of said user.

14. A method according to claim 1, wherein said identifying of said window is carried out by seeking a match between a value of at least one parameter of said window and a corresponding value of a template for identifying said window.

15. A method according to claim 14, wherein said identifying of said window is carried out at least in part by executing code.

16. A method according to claim 1, wherein said activating of said corresponding profile to said window comprises filling in at least one input field of said window according to said profile.

17. A system for rendering single sign on by a user, the system comprising:
a templates repository for storing at least one template for uniquely identifying a window, the templates repository being accessible by a machine of said user;
a profiles repository, accessible to said machine of said user, for storing at least one profile for filling-in at least one value in a corresponding input field of said window; and
an agent at said machine of said user, for identifying said window upon opening, and for activating a corresponding profile for filling-in at least one value in at least one input field of said window.

18. A system according to claim 17, wherein the profiles repository resides at the machine of said user.

19. A system according to claim 17, wherein the profiles repository resides at a remote location accessible over a network by the machine of said user.

20. A system according to claim 17, wherein the profiles repository resides at a security token accessible by the machine of said user.

21. A system according to claim 17, further comprising a manager, for distributing at least one said template to said user.

22. A system for rendering single sign on by a user, said system comprising a security token for storing information to be filled-in on behalf of said user in at least one input field of a window of a software application, thereby rendering single sign on without a server, and thereby securely storing said information.

23. A system according to claim 22, wherein said application is an Internet browser.
